(19) United States
(12) Patent Application Publication
(10) Pub. No.: US 2008/0215997 A1
(43) Pub. Date: Sep. 4, 2008

(54) WEBPAGE BLOCK TRACKING GADGET

(75) Inventors: Min Wu, Beijing (CN); Chenxi Lin, Beijing (CN); Benyu Zhang, Beijing (CN); HuaJun Zeng, Beijing (CN); Zheng Chen, Beijing (CN); Jian Wang, Beijing (CN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 12/038,687

(22) Filed: Feb. 27, 2008

Related U.S. Application Data
(60) Provisional application No. 60/892,409, filed on Mar. 1, 2007.

(51) Int. Cl. G06F 3/048

(52) U.S. Cl. 715/760

(57) ABSTRACT

An exemplary web browser system includes a selection module for selecting a webpage block and recording information about a selected webpage block; a tracking module for tracking changes to a selected webpage block based at least in part on the recorded information for that webpage block; and a display module for displaying a selected webpage block wherein the tracking module updates the display module as to changes to the selected webpage block. Various other exemplary systems, methods, devices are also disclosed.

### RELATED APPLICATION

This non-provisional patent application claims the benefit of and priority to U.S. Provisional Patent Application 60/892,409, entitled “A Webpage Block Tracking Gadget”, filed Mar. 1, 2007, which is incorporated by reference herein, in its entirety.

### BACKGROUND

Web users often want to save shortcuts to their interesting information on the Web for convenient re-use. One conventional way is to use “Favorites” folders to organize the URLs of interest so that they could be visited quickly next time. Some tools are also developed to help users organize their shortcuts. However, users may only be interested in some parts of the pages instead of the whole pages. In order to fulfill this requirement, various personalized homepage applications emerged recently on the Web to enable Web users to select Web contents of interest and to customize layouts and visual styles. The content selected may be referred to as a “block”. Various exemplary techniques described herein pertain to webpage block tracking or tracing techniques.

### SUMMARY

An exemplary web browser system includes a selection module for selecting a webpage block and recording information about a selected webpage block; a tracking module for tracking changes to a selected webpage block based at least in part on the recorded information for that webpage block; and a display module for displaying a selected webpage block wherein the tracking module updates the display module as to changes to the selected webpage block. Various other exemplary systems, methods, devices are also disclosed.

### DESCRIPTION OF THE DRAWINGS

Non-limiting and non-exhaustive examples are described with reference to the following figures:

FIG. 1 is a diagram of an exemplary block tracking system;

FIG. 2 is a diagram of an exemplary browser system;

FIG. 3 is a diagram of an exemplary method for selecting, tracking and displaying blocks; and

FIG. 4 is a diagram of an exemplary computing device and environment suitable for use in implementing various techniques described herein.

### DETAILED DESCRIPTION

The WINDOWS® LIVE® toolbar (Microsoft Corporation, Redmond, Wash.) includes various features. A particular feature allows users to build their own gadgets, which may be shared. As described herein, an exemplary gadget provides for a webpage block tracking technique that is able to track a variable webpage block. Through use of such a gadget, a user can arrange different kinds of webpage blocks on a single page (e.g., on a single page at http://www.live.com). This single page is referred to herein as the base page. Block tracking acts to maintain the content in base page and ensure it is updated as appropriate.

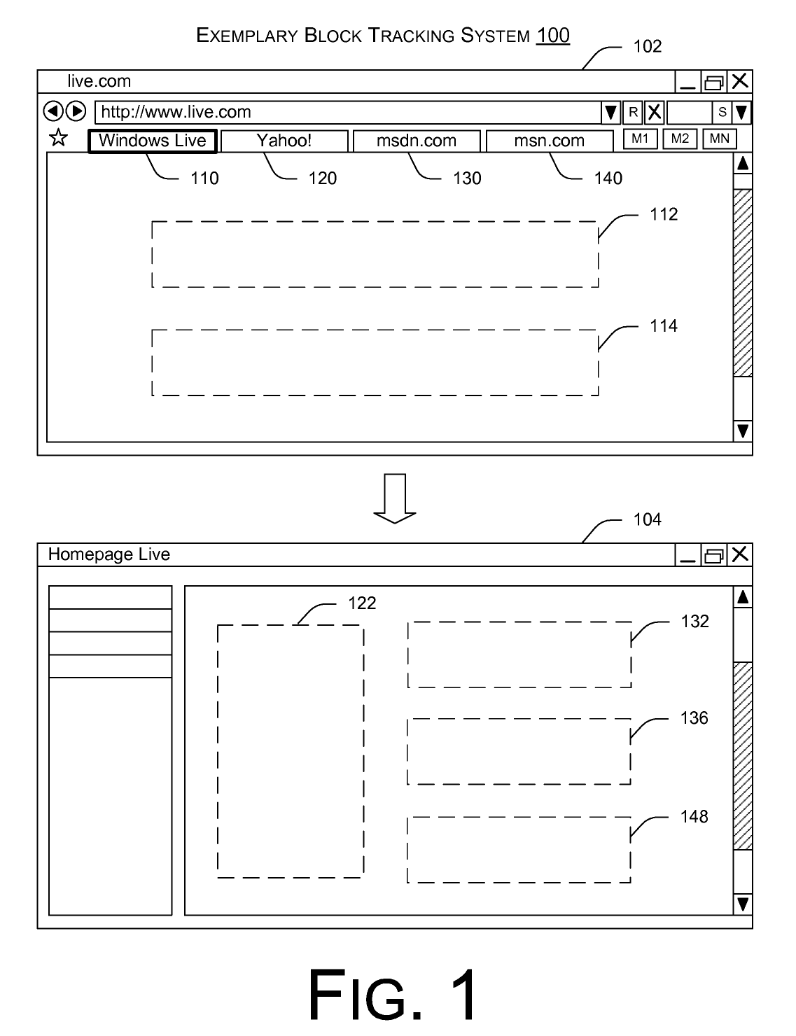

FIG. 1 shows an exemplary block tracking system 100. In the example of FIG. 1, a web browser application 102 includes various tabs 110, 120, 130 and 140 that correspond to different webpages. With the WINDOWS® LIVE® webpage tab 110 highlighted, the browser application 102 displays various content blocks 112 and 114. Similarly, the other tabs 120, 130 and 140 display content blocks for their respective webpages.

The browser application 102 includes a tool or add-on (e.g., a gadget) for selecting webpage blocks and aggregating these blocks to a separate GUI 104. In the example of FIG. 1, the GUI 104 is referred to as “Homepage Live”, which may be considered a base page for displaying webpage blocks. For example, webpage block 122 is from the webpage 120, webpage blocks 132 and 136 are from the webpage 130 and webpage block 148 is from the webpage 140. In such a manner, a user does not need to browse to the individual webpages as indicated by the tabs 120, 130, 140 but can instead view selected content (webpage blocks) by using the base page GUI.

In such an arrangement, the base page GUI 104 should track the blocks 122, 132, 136 and 148 to ensure that the content is up to date so the user can readily see and/or hear the selected content without having to browse to the individual source webpages. This process is referred to herein as block tracking or block tracing.

For example, when a user opens the base page again, a tracing algorithm can analyze the original pages and the new pages and can detect the new block position in the updated pages, and present the extracted new blocks to the user. As described herein, the tracing algorithm can be performed by a gadget.

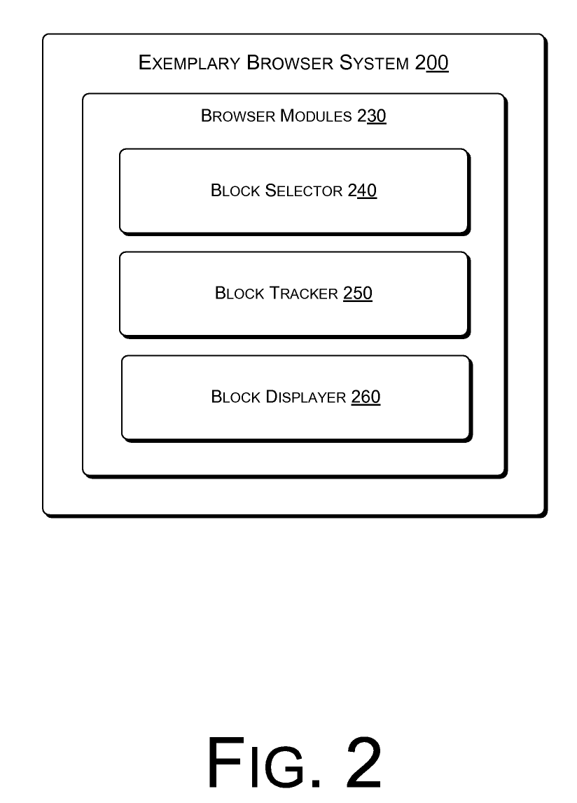

FIG. 2 shows an exemplary browser system 200 that includes modules 230. In this example, the browser system 200 includes a block selector module 240, a block tracker module 250 and a block displayer 260. The modules 240, 250 and 260 may be add-ons, gadgets, or otherwise configured for use with a browser system.

In the example of FIG. 2, the module 240 may be a browser toolbar component. For example, a user selects a webpage block using the toolbar component and then the toolbar component records information about the selected block for use by a daemon program (e.g., the block tracker module 250).

In the example of FIG. 2, the module 250 may be a daemon program that can automatically track one or more selected webpage blocks. This component can be a daemon program which will track webpage blocks according to the information recorded by a selector component (e.g., the block selector module 240). In an exemplary method, whenever the daemon program finds a change, it can update a display module or gadget (“url.html” and “block.html”) in Internet Information Services (IIS) (e.g., the display module 260).

In the example of FIG. 2, the display module 260 may be a gadget in IIS. For example, when a user visits the site http://www.live.com, the gadget in IIS is responsible for showing the tracked blocks. This component can be an existing gadget in local IIS of a user's computing device. When the gadget is invoked by entering a site (e.g., http://www.live.com), the tracked block in the webpage W (webpage W is the content webpage where the selected block lives) will be shown by the gadget by nesting an HTML iframe.

Because a security policy of a browser may prevent a webpage visiting a page in IFRAME from a different domain, two additional pages are used to help showing the right page and right block. As discussed, two pages “url.html” and “block.html” are used where “url.html” is composed of a big iframe, where the webpage W is nested in it. “block.html” also contains an iframe, where “url.html” lives. Since “block.html” and “url.html” are in the same domain, “block.html” is able to scroll the “url.html”. “block.html” can scroll “url.html”, and “url.html” contains the webpage W, so “block.html” can orient the block in W indirectly.

As described herein an exemplary web browser system includes a selection module for selecting a webpage block and recording information about a selected webpage block; a tracking module for tracking changes to a selected webpage block based at least in part on the recorded information for that webpage block; and a display module for displaying a selected webpage block wherein the tracking module updates the display module as to changes to the selected webpage block.

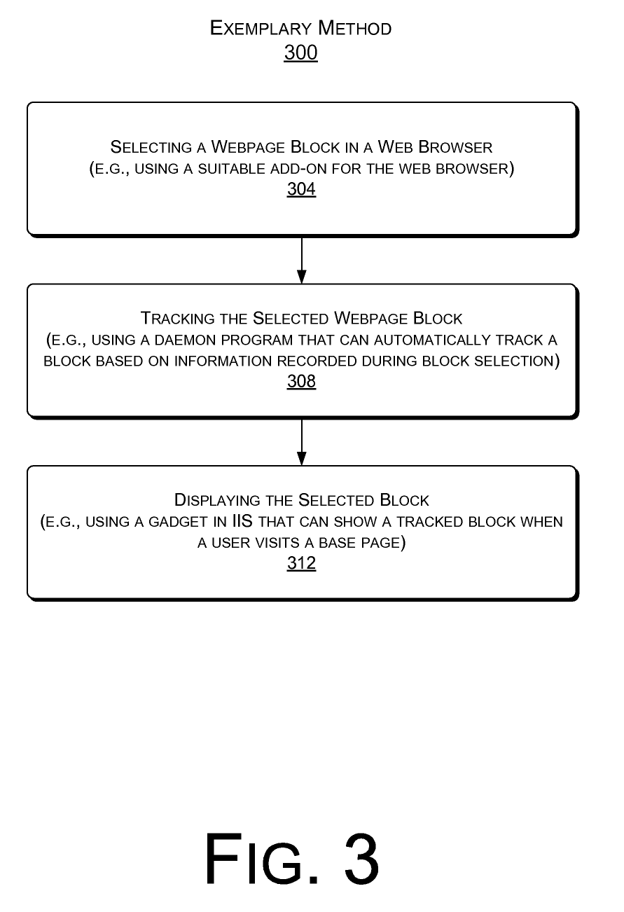

FIG. 3 shows an exemplary method 300 for block selection, tracking and display. In a selection step 304, a user selects a webpage block, for example, as displayed in a GUI of a web browser application. The selection step 304 may rely on a module like the module 240 of FIG. 2. In a tracking step 308, a program tracks the selected webpage block, for example, using a daemon program that runs in the background and operates based in part on information acquired or recorded during the selection step for that block. The tracking step 308 may rely on a module like the module 350 of FIG. 2. In a display step 312, a program displays the selected block, which may be a tracked, selected block per the selection step 304 and the tracking step 308. The display step 312 may use a gadget in IIS that can show a tracked block when a user visits a base page. The display step 312 may rely on a module like the module 260 of FIG. 2.

An exemplary gadget-based approach to webpage block tracking involves: (i) selecting a webpage block in a web browser using an add-on such as a webpage blocker add-on for the INTERNET EXPLORER® browser (Microsoft Corporation, Redmond, Wash.) (see, e.g., box 304 of FIG. 3); (ii) providing a daemon program to automatically track a webpage block based on information recorded by the webpage blocker (see, e.g., box 308 of FIG. 3); and (iii) using a gadget in Internet Information Services (IIS) that can show a tracked block when a user visits the base page (see, e.g., box 312 of FIG. 3).

Thus, as described herein, an exemplary method for tracking selected webpage blocks includes selecting a webpage block using a webpage block selector in a web browser, tracking a webpage block using a daemon program that uses information recorded by the webpage block selector and activating a gadget when a user visits a base page to display a tracked block.

An exemplary method for tracking a webpage block may include selecting a webpage block displayed in a web browser application graphical user interface (GUI); recording information about the selected webpage block; associating the selected webpage block with a base page; based at least in part on the recorded information, tracking the selected webpage block using a daemon program; and activating a gadget upon accessing the base page to display the selected, tracked block.

As described herein, a daemon program is a type of software program that can perform a housekeeping or maintenance utility function without being called by a user. A daemon program can sit in the background and be activated only when needed, for example, to correct an error from which another program cannot recover. For example, the aforementioned daemon program can be activated as needed to track a webpage block based on information from a browser-based webpage blocker (e.g., a blocker add-on).

As described herein, a gadget is typically defined by information written in mark-up language (e.g., easily consumable language) and stored in file. For example, a gadget may be defined using XML, which can be stored in an XML file. Often this information is called the gadget manifest. In such an example, the purpose of the manifest XML is to define a few of the static properties for the gadget and to provide URLs (or other locators) for script code for the gadget and optionally a style sheet for the gadget, where appropriate.

As described herein, a gadget may operate as part of or in conjunction with Internet Information Services (IIS). In general, IIS include software services that support Web site creation, configuration, and management, along with other Internet functions. ISS include Network News Transfer Protocol (NNTP), File Transfer Protocol (FTP), and Simple Mail Transfer Protocol (SMTP).

In a specific example, a user selects a webpage block in a browser, which is usually implemented using a component that is a toolbar add-on. Hence, a user can select a webpage block using a toolbar component (e.g., add-on or supplied) and, in turn, the toolbar component records information about the block for a daemon program to track.

A daemon program can automatically track a webpage block. In particular, a daemon program can track a webpage block according to information recorded by the toolbar component. More specifically, whenever the daemon program uncovers a change, the daemon program can update a gadget component that operates in IIS (see, e.g., “url.html” and “block.html” described below).

A gadget operating in IIS can be activated when user visits the base page (e.g., http://www.live.com) where the gadget in IIS is responsible for showing the tracked block.

A gadget component can be an existed gadget in local IIS of user's computer (e.g., a PC, etc.). When the gadget is invoked by a user visiting the base page (e.g., http://www.live.com), the tracked block in the webpage W (webpage W is the content webpage where the block user is interested in lives) will show up in the gadget through use of a nested HTML iframe. An “iframe” element exists as an object that can function to create a document within a document. Through use of an IFRAME tag in HTML, a user can create a floating frame (e.g., at a specified location in an HTML file).

In the INTERNET EXPLORER® browser, because of a security policy, the browser prevents a webpage from visiting a page in an IFRAME from different domain. Thus, as already mentioned, two additional pages are used to help show the right page and right block. These two pages are referred to herein as “url.html” and “block.html”. The page “url.html” is composed of a big iframe and the webpage “W” is nested in the url.html page.

The page “block.html” also contains an iframe, in which the page “url.html” lives. Since “block.html” and “url.html” are in the same domain, “block.html” is able to scroll the page “url.html”. Thus, the page “block.html” can scroll the page “url.html”, and the page “url.html” contains the webpage W, so, in turn, the page “block.html” can orient the block in webpage W indirectly.

Additional information is provided below that discusses some general aspects of certain types of gadgets (e.g., gadgets for use with www.live.com).

At the most basic level, a gadget can include the following three components:

1. Gadget Manifest—which is an XML file that defines several properties of a gadget, including the location of a gadget script file and a gadget style sheet.

2. Gadget Script file—this is typically a JavaScript file that includes code for creating a gadget.

3. Gadget Style Sheet—this is an optional CSS file that a user can use to help present a UI for a gadget.

Below is an example of a gadget manifest:

```
  <?xml version=“1.0”?>
  <rss version=“2.0” xmlns:binding=“http://www.live.com”>
    <channel>
      <!-- Specifies the name of your Gadget -->
      <title>Example Gadget</title>
      <!-- Gives a short description of your Gadget -->
      <description>Write a short description here.</description>
      <!-- Specifies the default locale for your Gadget -->
      <language>en-us</language>
      <!-- Specifies the JavaScript object that defines your Gadget
        (this object must be defined in the JavaScript linked to
        below) -->
      <binding:type>CompanyName.TeamName.Feature.ExampleGadget
      </binding:type>
      <item>
        <!-- Specifies the JavaScript file that contains the code for your
        Gadget -->
        <link>http://www.mydomain.com/Gadgets/ExampleGadget/
        ExampleGadget.js</link>
      </item>
      <item>
        <!-- Specifies the css file that contains the styles for your
        Gadget -->
        <link binding:type=“css”>
http://www.mydomain.com/Gadgets/ExampleGadget/ExampleGadget.css
  </link>
      </item>
      <icons>
        <!-- Specifies the icon to be displayed in the title bar for your
        Gadget -->
        <icon height=“32” width=“32”>
http://www.mydomain.com/Gadgets/ExampleGadget/TitleIcon.gif</icon>
      </icons>
    </channel>
  </rss>
```

As already mentioned, security policies can be applied to iframes. For example, in www.live.com, all third party gadgets run within independent iframes to ensure security. However, sometimes during development it may be useful to have www.live.com render a gadget inline without the iframe around it. The following code can be added to a gadget manifest to render without an iframe around the gadget:

```
<?xml version=“1.0”?>
<rss version=“2.0” xmlns:binding=“http://www.live.com”>
  <channel>
  ...
  <binding:options renderInline=“true”></binding:options>
  ...
  </channel>
</rss>
```

Note that this option should be removed before publishing a gadget on the web for general consumption. Otherwise, the gadget will throw an exception.

Embedding a Webpage as a Gadget: A user can load any webpage within a www.live.com webpage.

```
  this.initialize = function(p_objScope)
  {
    Gadget.Examples.LazyGadget.getBaseMethod(this, “initialize”,
“Web.Bindings.Base”).call(this, p_objScope);
    var url = “http://www.xbox.com/”
    m_iframe = document.createElement(“iframe”);
    m_iframe.scrolling = “yes”;
    m_iframe.frameBorder = “0”;
    m_iframe.src = url;
    m_iframe.width=“95%”;
    m_iframe.height=“285px”;
    p_elSource.appendChild(m_iframe);
  }
```

Each gadget for www.live.com is itself a binding. The gadget object itself is passed an HTML element as a parameter when it is created, and the object provides the JavaScript code that interacts with that element to define the contents of the gadget.

Gadgets run in an iframe (for third-party gadgets), a user can right-click the gadget frame on www.live.com, choose properties, and copy the iframe URL Then paste that into a new browser window and execute the gadget.

A gadget API provides robust mechanisms for consuming XML within gadgets. There is a built-in network proxy that allows gadget code to access XML regardless of where it is hosted, without worrying about cross-domain access issues.

In an example, two HTML files url.htm and block.htm are created by a deamon process automatically and http://www.live.com shows “url.html” as a gadget via local IIS services.

Block.htm

<body topmargin=0 leftmargin=0 marginwidth=0 marginheight=0
style=“border:0”>
<iframe name=“l2” src=“http://www.yahoo.com/” width=1049
height=694 scrolling=“NO”/>
</body>

URL.htm

<body topmargin=0 leftmargin=0 marginwidth=0 marginheight=0
style=‘border:0’>
<iframe name=“la3” src=“block.htm” onload=
“javascript:window.frames[‘la3’].scrollBy(572, 518)”
border=0 marginwidth=0 marginheight=0 scrolling=“NO”
width=329 height=119 />
</body>

In the Block.htm code, the margin/style portion of the code is to make sure the up-left corner of “Block.htm” is just the up-left corner of the webpage for http://www.yahoo.com.

In the URL.htm code, the margin/style portion of the code is to make sure the up-left corner of “URL.html” is just the point (572,518) in “Block.htm”.

Because the default value of “topmargin, leftmargin, marginwith, marginheight and border is not zero, it would otherwise lead to the movement of the position of the block.

An exemplary method for displaying a selected webpage block includes providing a first page that contains a frame (e.g., block.html) for a second page and providing the second page wherein the second page contains a frame for nesting a webpage block (e.g., url.html). In such a method, the first page can scroll the second page to thereby allow the first page to orient the webpage block. In such a method the first page and the second page may be HTML pages and the frame of the first page and the frame of the second page may be iframes.

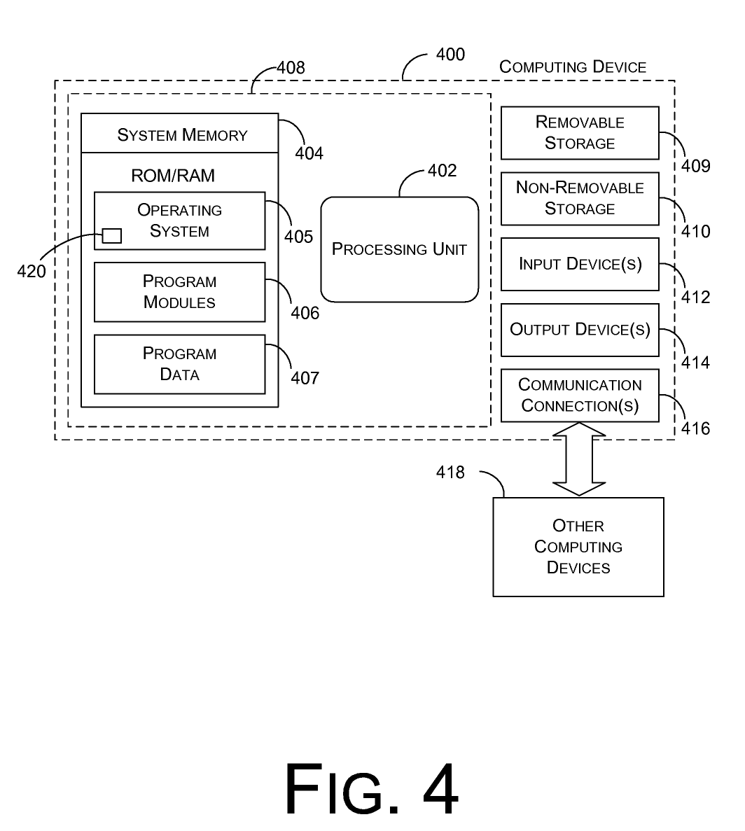

FIG. 4 shows various components of an exemplary computing device 200 that may be used to implement part or all of various exemplary methods discussed herein.

The computing device shown in FIG. 4 is only one example of a computer environment and is not intended to suggest any limitation as to the scope of use or functionality of the computer and network architectures. Neither should the computer environment be interpreted as having any dependency or requirement relating to any one or combination of components illustrated in the example computer environment.

With reference to FIG. 4, one exemplary system for implementing an exemplary web search mechanism (e.g., GUI, etc.) includes a computing device, such as computing device 400. In a very basic configuration, computing device 400 typically includes at least one processing unit 402 and system memory 404. Depending on the exact configuration and type of computing device, system memory 404 may be volatile (such as RAM), non-volatile (such as ROM, flash memory, etc.) or some combination of the two. System memory 404 typically includes an operating system 405, one or more program modules 406, and may include program data 407. This basic configuration is illustrated in FIG. 4 by those components within dashed line 408.

The operating system 405 may include a component-based framework 420 that supports components (including properties and events), objects, inheritance, polymorphism, reflection, and provides an object-oriented component-based application programming interface (API), such as that of the .NET™ Framework manufactured by Microsoft Corporation, Redmond, Wash.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by removable storage 409 and non-removable storage 410. Computer storage media may include volatile and nonvolatile, removable and non-removable media implemented in any method or technology for storage of information, such as computer readable instructions, data structures, program modules, or other data. System memory 404, removable storage 409 and non-removable storage 410 are all examples of computer storage media. Thus, computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of device 400. Computing device 400 may also have input device(s) 412 such as keyboard, mouse, pen, voice input device, touch input device, etc. Output device(s) 414 such as a display, speakers, printer, etc. may also be included. These devices are well know in the art and need not be discussed at length here.

Computing device 400 may also contain communication connections 416 that allow the device to communicate with other computing devices 418, such as over a network. Communication connection(s) 416 is one example of communication media. Communication media may typically be embodied by computer readable instructions, data structures, program modules, etc.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. These program modules and the like may be executed as native code or may be downloaded and executed, such as in a virtual machine or other just-in-time compilation execution environment. Typically, the functionality of the program modules may be combined or distributed as desired in various embodiments.

One skilled in the relevant art may recognize, however, that the techniques described herein may be practiced without one or more of the specific details, or with other methods, resources, materials, etc. In other instances, well known structures, resources, or operations have not been shown or described in detail merely to avoid obscuring aspects of various exemplary techniques.

While various examples and applications have been illustrated and described, it is to be understood that the techniques are not limited to the precise configuration and resources described above. Various modifications, changes, and variations apparent to those skilled in the art may be made in the arrangement, operation, and details of the methods and systems disclosed herein without departing from their practical scope.

1. A method for tracking a webpage block, implemented by a computing device, the method comprising:
selecting a webpage block displayed in a web browser application graphical user interface;
recording information about the selected webpage block;
associating the selected webpage block with a base page;
based at least in part on the recorded information, tracking the selected webpage block using a daemon program; and
activating a gadget upon accessing the base page to display the selected, tracked block.

2. The method of claim 1 further comprising selecting a plurality of webpage blocks and tracking the plurality of webpage blocks.

3. The method of claim 1 wherein the base page comprises a plurality of selected webpage blocks.

4. The method of claim 1 wherein the gadget comprises a gadget in Internet Information Services of the computing device.

5. The method of claim 1 wherein the tracking comprises detecting a change in the selected webpage block.

6. The method of claim 5 further comprising notifying the gadget of the detected change in the selected webpage block.

7. The method of claim 5 further comprising updating one or more files.

8. The method of claim 7 wherein the one or more files comprises at least one HTML file.

9. The method of claim 1 wherein the selecting comprises using a toolbar component of the web browser application.

10. The method of claim 1 wherein the displaying allows for scrolling in the selected and displayed webpage block.

11. A web browser system comprising:
a selection module for selecting a webpage block and recording information about a selected webpage block;
a tracking module for tracking changes to a selected webpage block based at least in part on the recorded information for that webpage block; and
a display module for displaying a selected webpage block wherein the tracking module updates the display module as to changes to the selected webpage block.

12. The web browser system of claim 11 wherein the selection module comprises a toolbar add-on.

13. The web browser system of claim 11 wherein the tracking module comprises a daemon program.

14. The web browser system of claim 11 wherein the display module comprises a gadget.

15. The web browser system of claim 11 wherein the display module comprises a program in a local Internet Information System.

16. The web browser system of claim 11 wherein the display module provides for scrolling the displayed webpage block.

17. The web browser system of claim 11 wherein the display module nests frames.

18. A method for displaying a selected webpage block, implemented by a computing device, the method comprising:
providing a first page that contains a frame (block.html) for a second page; and
providing the second page wherein the second page contains a frame for nesting a webpage block (url.html);

19. The method of claim 18 wherein the first page can scroll the second page to thereby allow the first page to orient the webpage block.

20. The method of claim 18 wherein the first page and the second page comprise HTML pages and wherein the frame of the first page and the frame of the second page comprise iframes.
